(19) United States
(12) Patent Application Publication
(10) Pub. No.: US 2026/0122428 A1
(43) Pub. Date: Apr. 30, 2026

(54) LOUDSPEAKER SYSTEM AND ELECTRONIC DEVICE

(71) Applicant: AAC Microtech (Changzhou) Co., Ltd., Changzhou City (CN)

(72) Inventors: Yufen Chu, Changzhou (CN); Yao Hui, Changzhou (CN); Ruyang Wang, Changzhou (CN)

(21) Appl. No.: 19/001,387

(22) Filed: Dec. 24, 2024

Related U.S. Application Data
(63) Continuation of application No. PCT/CN2024/127083, filed on Oct. 24, 2024.

(51) Int. Cl. H04R 9/06; H04R 7/02

(52) U.S. Cl. CPC H04R 9/06; H04R 7/02

(57) ABSTRACT

A loudspeaker system and an electronic device are provided according to the present disclosure. The loudspeaker system includes a first housing, where a first accommodating cavity is defined in the first housing, at least one passive diaphragm, arranged in the first accommodating cavity, a second housing, where a second accommodating cavity is defined in the second housing, an active diaphragm is provided in the second accommodating cavity, the second accommodating cavity is divided into a second front cavity and a second rear cavity by the active diaphragm, and the second rear cavity is in communication with the first rear cavity to form a closed cavity, a central magnetic block fixed on a side of the passive diaphragm away from the first front cavity and a magnetic assembly, including a first magnetic member arranged in the first front cavity and a second magnetic member arranged in the first rear cavity.

### TECHNICAL FIELD

Various embodiments of the present disclosure relate to the technical field of loudspeakers, and in particular to a loudspeaker system and an electronic device.

### BACKGROUND

With the rapid development of communication technology, the upgrading of electronic products is getting faster and faster, and the time and frequency of users' use of electronic products are significantly improved, which also puts forward high requirements for the music functions that can be realized in electronic products. As a bass unit, loudspeakers are also widely used in exiting smart electronic products. There are many parameters used to evaluate the sound quality of the loudspeaker, such as resonance frequency and low-frequency sensitivity. The loudspeaker mainly relies on the vibration of the diaphragm to promote air vibration to produce sound. When the stiffness of the diaphragm is large, it will increase the system stiffness of the loudspeaker, resulting in high resonance frequency and poor low-frequency sensitivity of the loudspeaker.

The low-frequency performance of conventional passive radiation loudspeakers is mainly limited by the stiffness and quality of the loudspeakers themselves. The diaphragm with excessive mass aggravates the vibration of the loudspeakers and reduce the user experience, while the diaphragm with low stiffness is difficult to process and has low yield, which makes it difficult to realize engineering application.

Therefore, it is necessary to provide a new loudspeaker system to solve the above technical problems.

### SUMMARY

An objective according to the embodiments of the present disclosure is to provide a loudspeaker system and an electronic device which can provide negative stiffness to the diaphragm and weaken the low-frequency vibration sensation of the loudspeaker.

In order to solve the above technical problems, a loudspeaker system is provided according to the embodiments of the present disclosure, and includes: a first housing provided with a first accommodating cavity, at least one passive diaphragm arranged in the first accommodating cavity and dividing the first accommodating cavity into a first front cavity and a first rear cavity, and a second housing provided with a second accommodating cavity, in which an active diaphragm is provided and divides the second accommodating cavity into a second front cavity and a second rear cavity, which are in communication with each other to form a closed cavity. The loudspeaker system further includes a central magnetic block fixed on a side of the passive diaphragm away from the first front cavity, and moving along with the vibration of the passive diaphragm in the first accommodating cavity in a first direction. The loudspeaker system further includes a magnetic assembly, including a first magnetic member arranged on an inner side wall of the first front cavity and a second magnetic member arranged on an inner side wall of the first rear cavity, where a magnetizing direction of the first magnetic member and a magnetizing direction of the second magnetic member are the same as a magnetizing direction of the central magnetic block, and a cooperative force of the first magnetic member and the second magnetic member on the central magnetic block is zero under a non-vibrating state of the passive diaphragm.

In an embodiment, a projection of the first magnetic member and a projection of the second magnetic member respectively at least partially overlap with a projection of the central magnetic block in the first direction.

In an embodiment, a first output port is defined on the first housing for communicating the first front cavity with an exterior, and the loudspeaker system radiates sound to the exterior of the first housing through the first output port.

In an embodiment, a plurality of passive diaphragms are provided, a plurality of central magnetic blocks are provided and are arranged in one-to-one correspondence with the plurality of passive diaphragms, and the plurality of passive diaphragms are arranged in the first accommodating cavity in the first direction and spaced apart with each other.

In an embodiment, the first rear cavity and the second rear cavity are communicated through at least one extension pipe to form the closed cavity.

In an embodiment, the first rear cavity and the second rear cavity are directly communicated to form a third rear cavity, the passive diaphragm is arranged between the first front cavity and the third rear cavity, and the active diaphragm is arranged between the second front cavity and the third rear cavity.

In an embodiment, a second output port is defined on the second housing for communicating the second front cavity with an exterior, and the loudspeaker system radiates sound to the exterior of the second housing through the second output port.

In an embodiment, the loudspeaker system further includes at least one intermediate cavity in communication with the second front cavity, a third output port is defined on the at least one intermediate cavity for communicating the second front cavity with an exterior, and the loudspeaker system radiates sound to the exterior of the second housing through the third output port.

Based on the loudspeaker system, an electronic device including the loudspeaker system described in any of the above is further provided according to the embodiments of the present disclosure.

The embodiments of the present disclosure have the beneficial effects that the passive diaphragm is provided with the central magnetic block capable of vibrating with the passive diaphragm in the first direction, and the magnetic assembly with the same magnetizing direction as the central magnetic block is arranged in the first housing. When the active diaphragm is driven to vibrate, it drives the passive diaphragm to vibrate in the first accommodating cavity in the first direction by influencing the air pressure of the closed cavity formed by the second rear cavity and the first rear cavity, so that the cooperative force of the first magnetic member and the second magnetic member on the central magnetic block is changed. When the passive diaphragm vibrates in the first direction, the vibration of the passive diaphragm in the first accommodating cavity is blocked by the attractive force formed between the central magnetic block and the magnetic assembly. According to the embodiments of the present disclosure, the equivalent stiffness of the passive diaphragm is reduced by providing the magnetic assembly. Moreover, by arranging the first magnetic member and the second magnetic member in the same magnetizing direction as the central magnetic block, under the condition of not increasing the mass of the passive diaphragm and not requiring the stiffness of the passive diaphragm itself, the low-frequency sound absorption is realized with a very small depth of the first accommodating cavity, so that the size requirement of the loudspeaker is reduced, the low-frequency vibration sensation of the loudspeaker system is weakened, and the low-frequency performance of the loudspeaker system is effectively improved.

### BRIEF DESCRIPTION OF THE DRAWINGS

In order to explain the technical solution of the present disclosure more clearly, a brief introduction will be given to the accompanying drawings required for the description of the embodiments. Obviously, the drawings in the following description are only some embodiments of the present disclosure, and other drawings can be obtained according to these drawings without creative efforts.

FIG. 1 is a schematic structural diagram of a passive radiator unit provided according to an embodiment of the present disclosure.

FIG. 2 is a schematic structural diagram of another passive radiator unit provided according to an embodiment of the present disclosure.

FIG. 3 is a schematic structural diagram of a loudspeaker system provided according to an embodiment of the present disclosure.

FIG. 4 is a structural schematic diagram of another loudspeaker system provided according to an embodiment of the present disclosure.

FIG. 5 is another structural schematic diagram of the passive radiator unit shown in FIG. 1.

FIG. 6 is a schematic structural diagram of a passive radiator unit provided in the conventional technology.

FIG. 7 is an equivalent circuit diagram of the passive radiator unit shown in FIG. 1.

FIG. 8 is a comparison diagram of sound pressure level curves of the passive radiator unit shown in FIG. 1 and the passive radiator unit shown in FIG. 6.

FIG. 9 is a comparison diagram of displacement curves of the passive radiator unit shown in FIG. 1 and the passive radiator unit shown in FIG. 6.

FIG. 10 is an equivalent circuit diagram of the loudspeaker system shown in FIG. 3.

FIG. 11 is a comparison diagram of sound pressure level curves of the loudspeaker system provided in the conventional technology and the loudspeaker system shown in FIG. 3.

FIG. 12 is a comparison diagram of the variation of the force on the diaphragm with frequency between the loudspeaker system provided in the conventional technology and the loudspeaker system shown in FIG. 3.

Reference numerals are listed as follows:

| | |
|---|---|
| 1- passive radiator unit; | 2-driver unit; |
| 10- first housing; | 11- first accommodating cavity; |
| 111- first front cavity; | 112- first rear cavity; |
| 12- first output port; | 20- passive diaphragm; |
| 201- vibration portion; | 202- folding annular portion; |
| 203- fixed portion; | 21- central magnetic block; |
| 30- magnetic assembly; | 31- first magnetic member; |
| 32-second magnetic member; | 33- magnetic block; |
| 40- second housing; | 41- second accommodating cavity; |
| 411- second front cavity; | 412- second rear cavity; |
| 42- second output port; | 43-extension pipe; |
| 50-active diaphragm; | 60- intermediate cavity; |
| 61- third output port; | 62- third rear cavity. |

### DETAILED DESCRIPTION OF THE EMBODIMENTS

In the following, the technical solution in the present disclosure will be clearly and completely described with reference to the attached drawings. Obviously, the described embodiments are only a part of the embodiments of the present disclosure, not all the embodiments. Based on the embodiments in the present disclosure, all other embodiments obtained by those skilled in the art without creative efforts fall within the protection scope of the present disclosure.

Referring to FIG. 1 to FIG. 12, a loudspeaker system and an electronic device are provided according to the embodiments of the present disclosure, which can reduce the equivalent stiffness of the passive diaphragm, weaken the low-frequency vibration sensation of the loudspeaker system, and improve the low-frequency performance of the loudspeaker system.

Referring to FIG. 1, FIG. 1 is a schematic structural diagram of a passive radiator unit provided in an embodiment of the present disclosure. The loudspeaker system provided by the embodiment of present disclosure includes a first housing 10, at least one passive diaphragm 20, a central magnetic block 21, a magnetic assembly 30, and a second housing 40.

As an optional embodiment, a first accommodating cavity 11 is defined in the first housing 10, the at least one passive diaphragm 20 is arranged in the first accommodating cavity 11 to be capable of vibration in a first accommodating cavity 11 in the first direction and to divide the first accommodating cavity 11 into a first front cavity 111 and a first rear cavity 112.

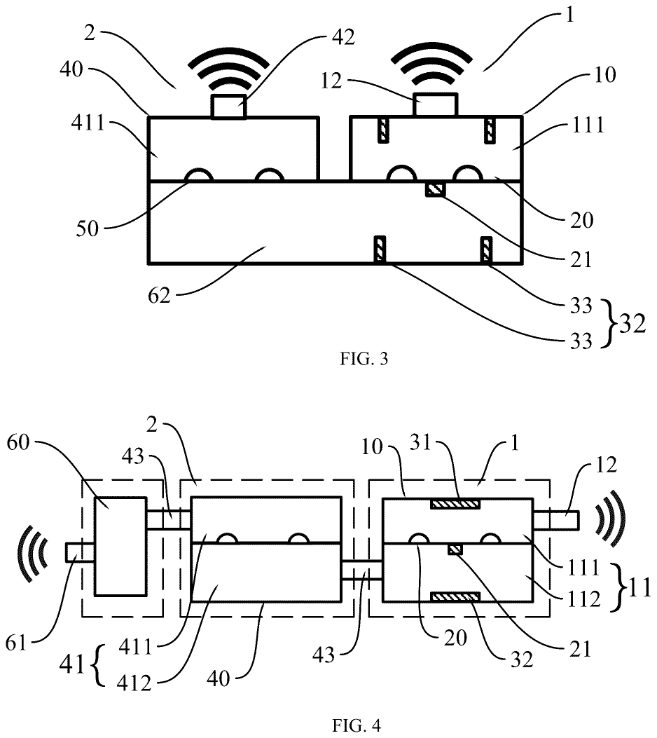

Further, referring to FIG. 3, FIG. 3 is a schematic structural diagram of a loudspeaker system provided according to an embodiment of the present disclosure. In the embodiment of the present disclosure, a second accommodating cavity 41 is correspondingly arranged in the second housing 40, and an active diaphragm 50 is arranged in the second accommodating cavity 41, so that the active diaphragm 50 can vibrate in the first direction. The second accommodating cavity 41 is divided into two cavities, i.e. a second front cavity 411 and a second rear cavity 412, by the active diaphragm 50, the second rear cavity 412 is in communication with the first rear cavity 112 to form a closed cavity, and the active diaphragm 50 is driven by electricity to vibrate inside the second housing 40.

As an optional embodiment, in the embodiment of the present disclosure, the central magnetic block 21 is fixed on a side of the passive diaphragm 20 away from the first front cavity 111. Since the central magnetic block 21 is fixedly arranged on the passive diaphragm 20, when the passive diaphragm 20 vibrates in the first accommodating cavity 11 in the first direction, the central magnetic block 21 arranged on the passive diaphragm 20 can also vibrate in the first accommodating cavity 11 in the first direction with the passive diaphragm 20, thus accompanying the vibration of the passive diaphragm 20 in the first accommodating cavity 11 in the first direction.

In an embodiment of the present disclosure, the magnetic assembly 30 includes a first magnetic member 31 and a second magnetic member 32. The first magnetic member 31 and the second magnetic member 32 are arranged in the first front cavity 111 and the first rear cavity 112 respectively, and are arranged on two opposite sides of the central magnetic block 21 in the first direction. Preferably, the first magnetic member 31 and the second magnetic member 32 are fixed to an inner side wall of the first housing 10 facing the passive diaphragm 20. By controlling a magnetizing direction of the magnetic assembly 30 and a magnetizing direction of the central magnetic block 21, the vibration of the passive diaphragm 20 in the first accommodating cavity 11 in the first direction can be correspondingly controlled.

Further, the magnetizing direction of the first magnetic member 31 and the magnetizing direction of the second magnetic member 32 are the same, so that a cooperative force of the first magnetic member 31 and the second magnetic member 32 on the central magnetic block 21 is zero when the passive diaphragm 20 is in a non-vibrating state.

It should be understood that when the passive diaphragm 20 is in a static state, the cooperative force of the first magnetic member 31 and the second magnetic member 32 on the opposite sides on the passive diaphragm 20 is zero. Since the magnetic assembly 30 is in the same magnetizing direction as the first magnetic member 31 and the second magnetic member 32, the cooperative force of the magnetic attractive force of the first magnetic member 31 and the second magnetic member 32 on two sides on the central magnetic block 21 is zero.

Since the second rear cavity 412 is in communication with the first rear cavity 112 to form a closed cavity, when the active diaphragm 50 is driven by electricity to vibrate in the second accommodating cavity 41 in the first direction, an internal air pressure between the second rear cavity 412 and the first rear cavity 112 is affected, and the fluctuation of the internal air pressure causes the passive diaphragm 20 to vibrate in the first accommodating cavity 11 in the first direction. As a result, the cooperative force of the attractive forces of the first magnetic member 31 and the second magnetic member 32 on the central magnetic block 21 is changed, and the first magnetic member 31 and the second magnetic member 32 are in the same magnetizing direction as the central magnetic block 21. Therefore, when the passive diaphragm 20 vibrates in the first direction, the attractive force on the central magnetic block 21 may block the vibration of the passive diaphragm 20 in the first accommodating cavity 11, thereby providing negative stiffness for the passive diaphragm 20 in the driver unit 2, so that the driver unit 2 radiates the required audio frequency outward.

It should be understood that the magnetic assembly 30 is arranged in the same magnetizing direction as the first magnetic member 31 and the second magnetic member 32, so that when the passive diaphragm 20 vibrates in the first direction, the central magnetic block 21 fixed on the passive diaphragm 20 is attracted by the first magnetic member 31 and the second magnetic member 32 on both sides, which blocks the vibration of the passive diaphragm 20 in the first accommodating cavity 11 in the first direction.

Further, since the magnetic assembly 30 is arranged in the same magnetizing direction as the central magnetic block 21, the attractive force formed by the central magnetic block 21 and the magnetic assembly 30 arranged in the first accommodating cavity 11 hinders the vibration of the passive diaphragm 20 in the first accommodating cavity 11 in the first direction, thus providing negative stiffness for the passive diaphragm 20, and realizing low-frequency sound absorption with a very small depth of the first accommodating cavity 11 without increasing the mass of the passive diaphragm 20 and requiring the stiffness of the passive diaphragm 20 itself, which weakens the low-frequency vibration sensation of the loudspeaker system and reduces the size requirements of the loudspeaker system.

It should be noted that negative stiffness refers to the phenomenon that the deformation of an object decreases with an increase of an external force under the action of the external force. Under normal circumstances, the deformation of the object increases with the increase of external force, while negative stiffness is the opposite phenomenon, that is, the deformation of the object decreases with the increase of the external force. In this embodiment of the present disclosure, the magnetic assembly 30 is arranged in the same magnetization direction as the central magnetic block 21. The attractive force of the magnetic assembly 30 to the central magnetic block 21 prevents the passive diaphragm 20 from vibrating in the first accommodating cavity 11 in the first direction, and reduces the vibration distance of the passive diaphragm 20 in the first direction, thus meeting the negative stiffness requirement of the passive diaphragm 20.

It should be noted that when the passive diaphragm 20 is in a non-vibrating state, the cooperative force of the attractive forces of the first magnetic member 31 and the second magnetic member 32 on opposite sides on the central magnetic block 21 is zero. When the passive diaphragm 20 needs to vibrate, the active diaphragm 50 is driven to vibrate, which affects the internal air pressure between the second rear cavity 412 and the first rear cavity 112, so that the passive diaphragm 20 vibrates in the first accommodating cavity 11 in the first direction. When the passive diaphragm 20 vibrates, the attractive force formed between the central magnetic block 21 and the magnetic assembly 30 further blocks the vibration of the passive diaphragm 20 in the first accommodating cavity 11 in the first direction, thus providing negative stiffness for the passive diaphragm 20 without increasing the mass of the passive diaphragm 20 and requiring the stiffness of the passive diaphragm 20 itself.

In an optional embodiment, the first magnetic member 31 and the second magnetic member 32 respectively at least partially overlap with a projection of the central magnetic block 21 in the first direction, so as to ensure the magnetic attractive force effect formed among the first magnetic member 31, the second magnetic member 32 and the central magnetic block 21.

Further, the first magnetic member 31 and the second magnetic member 32 are arranged in the form of magnetic blocks 33, In this case, both the first magnetic member 31 and the second magnetic member 32 include at least one magnetic block 33.

Referring to FIG. 1, when each of the first magnetic member 31 and the second magnetic member 32 includes a magnetic block 33, it can be seen that the two magnetic blocks 33 are arranged on opposite sides of the passive diaphragm 20 in the first direction, with a certain distance between the two blocks and the passive diaphragm 20, and the projections of the two magnetic blocks 33 partially overlap with the projection of the central magnetic block 21 in the first direction. In the embodiment of the present disclosure, one magnetic block 33 is arranged in the first front cavity 111, the other magnetic block 33 is arranged in the first rear cavity 112, and the magnetizing directions of the two magnetic blocks 33 are the same as the magnetizing direction of the central magnetic block 21. In the initial state, the attractive forces of the upper and lower magnetic blocks 33 on the central magnetic block 21 are balanced, that is, the cooperative force of the attractive forces of the upper and lower magnetic blocks 33 on the central magnetic block 21 is zero, and the passive diaphragm 20 is in the static state at this time.

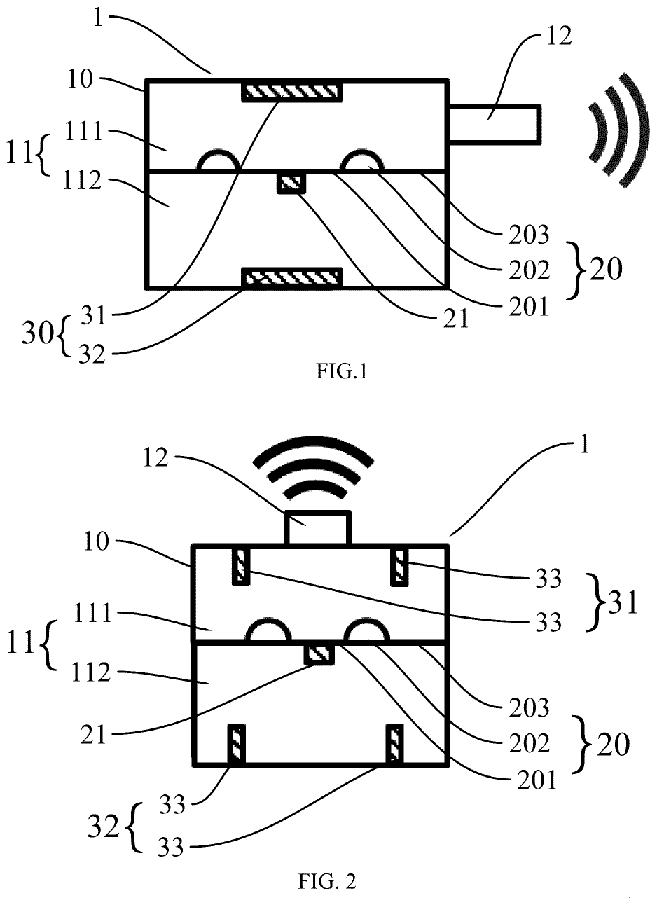

Referring to FIG. 2, FIG. 2 is a schematic structural diagram of another passive radiator unit according to an embodiment of the present disclosure. When each of the first magnetic member 31 and the second magnetic member 32 includes two magnetic blocks 33, it can be seen that the two magnetic blocks 33 included in the first magnetic member 31 and the two magnetic blocks 33 included in the second magnetic member 32 are arranged on two opposite sides of the passive diaphragm 20 in the first direction, with a certain distance between the passive diaphragm 20 and the blocks. The two magnetic blocks 33 included in the first magnetic member 31 are arranged in the first front cavity 111, and the two magnetic blocks 33 included in the second magnetic member 32 are arranged in the first rear cavity 112 and fixed on an inner side wall of the first housing 10. At this time, two magnetic blocks 33 are respectively arranged on each of the two opposite sides of the passive diaphragm 20.

Similarly, the magnetizing directions of the four magnetic blocks 33 are the same as that of the central magnetic block 21, two magnetic blocks 33 are fixed above the central magnetic block 21 and two magnetic blocks 33 are fixed below the central magnetic block 21. In the initial state, the attractive forces of the upper and lower magnetic blocks 33 on the central magnetic block 21 are balanced, that is, the cooperative force of the attractive forces of the upper and lower four magnetic blocks 33 on the central magnetic block 21 is zero, and the passive diaphragm 20 is in the static state at this time.

Alternatively, the projections of the two magnetic blocks 33 included in the first magnetic member 31 and the two magnetic blocks 33 included in the second magnetic member 32 shown in FIG. 2 do not partially overlap with the projection of the central magnetic block 21 in the first direction, and the positions of the upper and lower magnetic blocks 33 are adjusted accordingly to partially overlap with the central magnetic block 21 in the first direction, which is feasible. Those skilled in the art can adjust the installation position of the magnetic blocks 33 according to actual needs. In principle, other installation forms are feasible as long as the magnetic assembly 30 is arranged on the inner side wall of the first housing 10 to be opposite to the central magnetic block 21, and the cooperative force of the magnetic attractive forces of the first magnetic member 31 and the second magnetic member 32 on opposite sides on the central magnetic block 21 is zero when the passive diaphragm 20 does not need to vibrate. The embodiments of the present disclosure do not further limit the specific installation position of the magnetic blocks 33 and the specific installation number of the magnetic blocks 33 in the first magnetic member 31 and the second magnetic member 32.

As an optional embodiment, referring to FIG. 1, the passive diaphragm 20 according to the embodiment of the present disclosure includes a vibrating portion 201, a folding annular portion 202 connected with an edge of the vibrating portion 201, and a fixed portion 203 connected with an edge of the folded annular portion 202. By fixing an end of the fixed portion 203 away from the vibrating portion 201 on the inner side wall of the first housing 10, the passive diaphragm 20 is integrally connected to the inner side wall of the first housing 10. The first accommodating cavity 11 is divided into a first front cavity 111 and a second front cavity 112 by the passive diaphragm 20.

Preferably, the central magnetic block 21 is fixedly arranged on a side of the vibrating portion 201 away from the first front cavity 111.

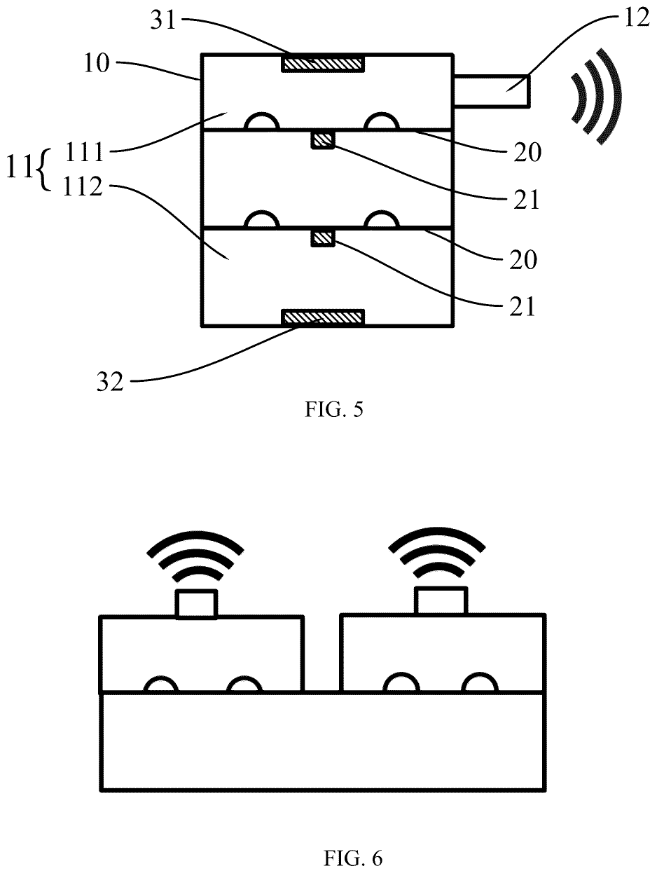

Referring to FIG. 5, FIG. 5 is another structural schematic diagram of the passive radiator unit shown in FIG. 1. A plurality of passive diaphragms 20 can be provided according to requirements. When two or more passive diaphragms 20 are provided, the plurality of passive diaphragms 20 can be arranged in the first accommodating cavity 11 in the first direction, and are spaced apart, so as to avoid affecting the vibration of other passive diaphragms 20 in the first direction due to too close distance. Each passive diaphragm 20 needs to be provided with a corresponding central magnetic block 21, so as to meet the one-to-one correspondence between passive diaphragms 20 and the central magnetic blocks 21.

Similarly, the two opposite sides of the central magnetic block 21 are respectively provided with a first magnetic member 31 and a second magnetic member 32, which are fixedly arranged on the inner side wall of the first housing 10, so that the cooperative force of the first magnetic member 31 and the second magnetic member 32 on the central magnetic block 21 fixed to each respective of the plurality of passive diaphragms 20 under the non-vibrating state is zero.

It should be understood that when the plurality of passive diaphragms 20 are arranged in the first housing 10, a closed cavity is formed between the first rear cavity 112 and the second rear cavity 412, and a closed cavity is also formed between every two passive diaphragms 20 of the plurality of passive diaphragms 20.

Referring to FIG. 5, in a specific embodiment according to the present disclosure, two passive diaphragms 20 are arranged in the first housing 10. It can be seen that each passive diaphragm 20 is fixedly provided with a corresponding central magnetic block 21, the first magnetic member 31 is fixedly arranged on the inner side wall of the first front cavity 111, and the second magnetic member 32 is fixedly arranged on the inner side wall of the first rear cavity 112. At this time, a closed cavity is also formed between the two passive diaphragms 20, so that the active diaphragm 50 drives the passive diaphragm 20 close to the first rear cavity 112 to vibrate while the active diaphragm 50 vibrates, and further drive the passive diaphragm 20 close to the first front cavity 111 to vibrate. The principle of the present disclosure will not be described in detail.

Although the above embodiments only show the arrangement of two passive diaphragms 20 and two central magnetic blocks 21, it is a simple extension in the art to arrange a plurality of passive diaphragms 20 and corresponding central magnetic blocks 21. If the accommodating volume of the first housing 10 and the cost permit, the number and arrangement position of the passive diaphragms 20 and the central magnetic blocks 21 can be adjusted adaptively, so that the loudspeaker system according to the embodiment of the present disclosure can be adjusted to the required frequency more easily.

As an optional embodiment, a first output port 12 is defined on the first housing 10 according to the embodiment of the present disclosure for communicating the first front cavity 111 with an exterior, so that the loudspeaker system can radiate the generated low-frequency sound to the exterior of the first housing 10 through the first output port 12, thereby achieving the multi-stage resonance requirement of the loudspeaker system.

Referring to FIG. 4, FIG. 4 is a schematic structural diagram of another loudspeaker system according to an embodiment of the present disclosure. The second rear cavity 412 and the first rear cavity 112 can be communicated through at least one extension pipe 43, and a closed space is formed between the first rear cavity 112, the at least one extension pipe 43 and the second rear cavity 412. When the active diaphragm 50 is driven by electricity to vibrate in the second accommodating cavity 41 in the first direction, the internal air pressure between the second rear cavity 412, the at least one extension pipe 43 and the first rear cavity 112 is affected, and the fluctuation of the internal air pressure causes the passive diaphragm 20 to vibrate in the first accommodating cavity 11 in the first direction. Since the central magnetic block 21 is in the same magnetizing direction as the magnetic assembly 30, the attractive force formed between the passive diaphragm 20 and the central magnetic block 21 when the passive diaphragm 20 vibrates in the first direction blocks the vibration of the passive diaphragm 20 in the first accommodating cavity 11, thereby providing negative stiffness for the passive diaphragm 20 in the driver unit 2, so that the driver unit 2 radiates the required audio frequency outward.

As an optional embodiment, referring to FIG. 3, the first rear cavity 112 and the second rear cavity 412 are directly communicated to form a third rear cavity 62. In this case, the first rear cavity 112 and the second rear cavity 412 do not need to be communicated with each other through an extension pipe 43, but directly form a closed third rear cavity 62. Further, the passive diaphragm 20 is arranged between the first front cavity 111 and the third rear cavity 62, and the active diaphragm 50 is arranged between the second front cavity 411 and the third rear cavity 62.

As an optional embodiment, the passive radiator unit 1 is formed by the passive diaphragm 20, the central magnetic block 21 arranged on the passive diaphragm 20 and the magnetic assembly 30 fixed on the inner side wall of the first housing 10, the driver unit 2 is formed by the active diaphragm 50, the passive radiator unit 1 is arranged between the first front cavity 111 and the third rear cavity 62, and the driver unit 2 is arranged between the second front cavity 411 and the third rear cavity 62. The passive diaphragm 20 in the passive radiator unit 1 is driven by the active diaphragm 50 in the driver unit 2.

Similarly, when the active diaphragm 50 vibrates between the second front cavity 411 and the third rear cavity 62, it affects the internal air pressure between the whole closed cavity formed by the third rear cavity 62, and the fluctuation of the internal air pressure causes the passive diaphragm 20 to vibrate in the first accommodating cavity 11 in the first direction, thereby effectively saving the volume required by the loudspeaker system.

It should be understood that, referring to FIG. 3, when the second rear cavity 412 and the first rear cavity 112 are communicated through at least one extension pipe 43, the passive radiator unit 1 can be placed inside the first housing 10, and the driver unit 2 can be placed inside the second housing 40. When the active diaphragm 50 is driven by electricity to vibrate inside the second housing 40, it affects the internal air pressure between the second rear cavity 412, the extension pipe 43, and the first rear cavity 112, which will not be described in detail herein by the embodiments of the present disclosure.

As an optional embodiment, a second output port 42 is defined on the second housing 40 according to the embodiment of the present disclosure for communicating the second front cavity 411 with an exterior, so that the loudspeaker system radiates sound to the exterior of the second housing 40 through the second output port 42, thereby achieving the multi-stage resonance requirement of the loudspeaker system.

Referring to FIG. 4, the loudspeaker system according to the embodiment of the present disclosure further includes at least one intermediate cavity 60 in communication with the second front cavity 411, and a third output port 61 is defined on the at least one intermediate cavity 60 according to the embodiment of the present disclosure for communicating the second front cavity 411 with an exterior, so that the loudspeaker system radiates sound to the exterior of the second housing 40 through the third output port 61. The specific number of intermediate cavities 60 and extension pipes 43 mentioned above is not further limited by the present disclosure.

Referring to FIG. 6, FIG. 6 is a schematic structural diagram of a passive radiator unit provided in the conventional technology. It can be seen that compared with the passive radiator unit 1 provided in the conventional technology, the passive radiator unit 1 provided by the present disclosure is provided with a central magnetic block 21 and a magnetic assembly 30 that forms a magnetic attractive force with the central magnetic block 21, thereby providing a negative stiffness for the passive diaphragm 20, which can effectively reduce the mass of the passive diaphragm and weaken the low-frequency vibration under the requirement of the same frequency design as the passive radiator unit in the conventional technology.

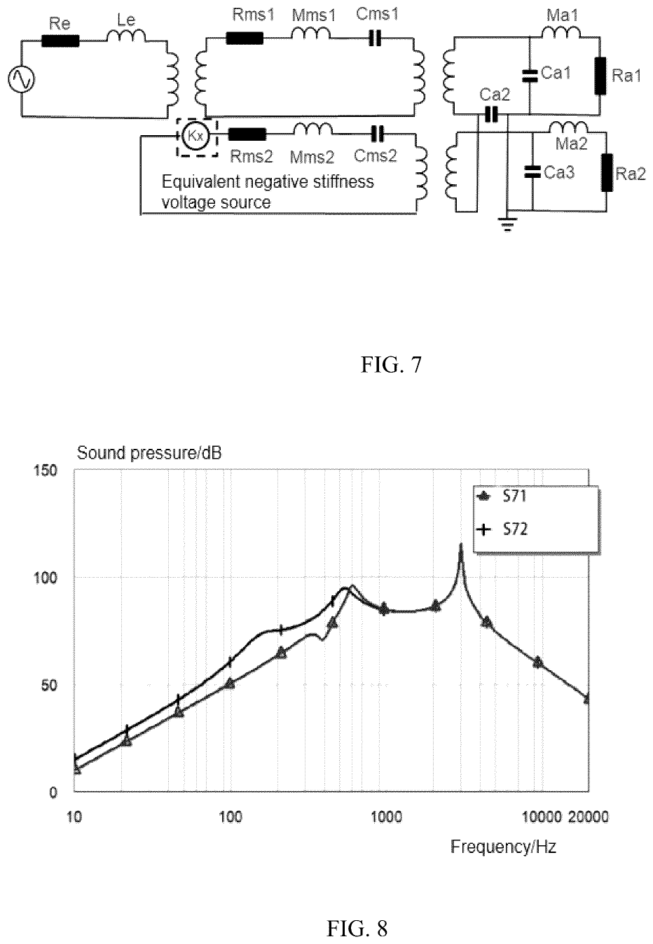

Referring to FIG. 7, FIG. 7 is an equivalent circuit diagram of the passive radiator unit shown in FIG. 1. It can be seen that by arranging the central magnetic block 21 and the magnetic assembly 30 in the passive radiator unit 1, the equivalent negative stiffness voltage source is added to the structure of the conventional passive radiator unit 1, thereby reducing the equivalent stiffness of the passive diaphragm 20.

Referring to FIG. 8, FIG. 8 is a comparison diagram of sound pressure curves of the passive radiator unit shown in FIG. 1 and the passive radiator unit shown in FIG. 6. In FIG. 8, the abscissa is frequency in Hz, and the ordinate is sound pressure value in dB. The curve of triangle mark S71 in FIG. 8 is the frequency response curve of the passive radiator unit provided by the conventional technology, and the curve of line mark S72 in FIG. 8 is the frequency response curve of the passive radiator unit provided by the present disclosure. By comparison, it can be clearly seen that the resonant frequency of the passive radiator unit provided by the present disclosure is lower and the low-frequency sensitivity is better.

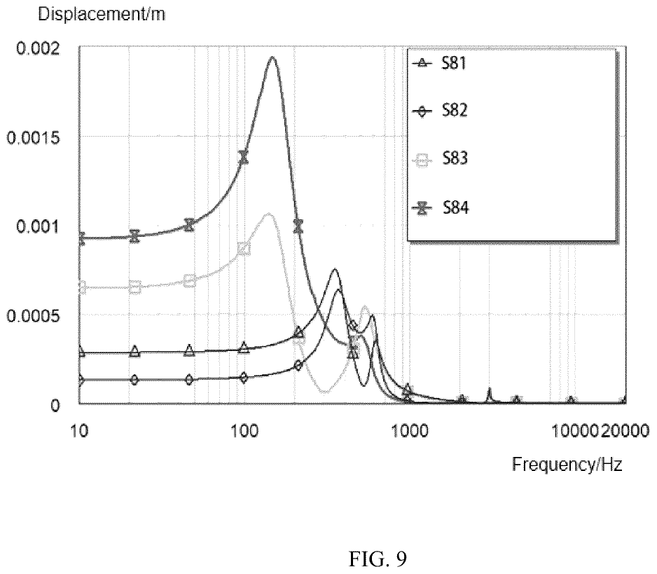

Referring to FIG. 9, FIG. 9 is a comparison diagram of displacement curves of the passive radiator unit shown in FIG. 1 and the passive radiator unit shown in FIG. 6. In FIG. 9, the abscissa is the frequency in Hz, and the ordinate is the displacement of the active diaphragm 50 and the passive diaphragm 20 vibrating in the first direction in m. The curves of triangle mark S81 and diamond mark S82 in FIG. 9 are the frequency displacement curves of the active diaphragm and the passive diaphragm in the passive radiator unit provided by conventional technology, while the curves of rectangle mark S83 and hourglass mark S84 in FIG. 9 are the frequency displacement curves of the active diaphragm 50 and the passive diaphragm 20 in the passive radiator unit 1 provided by the present disclosure. By comparison, it can be seen that the passive radiator unit 1 provided by the present disclosure reduces the resonance frequency of the passive diaphragm 20 and increases the low-frequency displacement of the passive diaphragm 20 at low frequency, thereby effectively improving the low-frequency performance of the passive radiator unit 1.

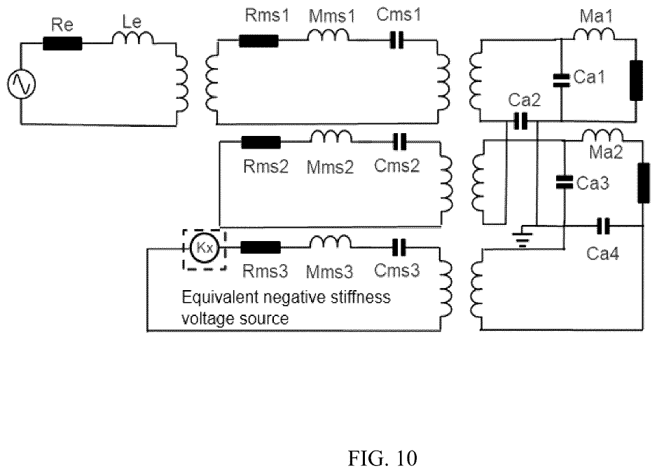

Further, referring to FIG. 10, FIG. 10 is an equivalent circuit diagram of the loudspeaker system shown in FIG. 3. It can be seen that compared with the loudspeaker system in the conventional technology, an equivalent negative stiffness voltage source is added by the loudspeaker system provided by the present disclosure, so the negative stiffness of the passive diaphragm 20 can be adjusted.

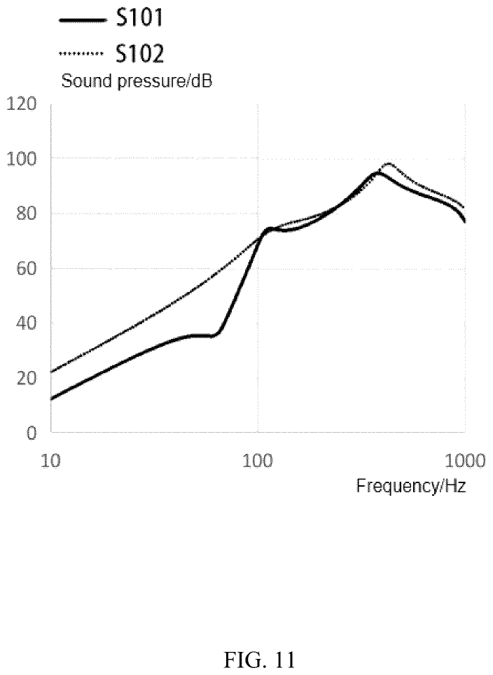

Specifically, referring to FIG. 11, FIG. 11 is a comparison diagram of sound pressure curves of the loudspeaker system provided in the conventional technology and the loudspeaker system shown in FIG. 3. In FIG. 11, the abscissa is frequency in Hz, and the ordinate is sound pressure value in dB. In FIG. 11, the solid line S101 is the frequency response curve of the loudspeaker system provided by the conventional technology, and the dashed line S102 is the frequency response curve of the passive radiator unit provided by the present disclosure. By comparison, it can be clearly seen that the loudspeaker system provided by the present disclosure has significantly improved the low-frequency SPL (Sound Pressure Level) and weakened the low-frequency vibration sensation while maintaining the same low-frequency resonance frequency.

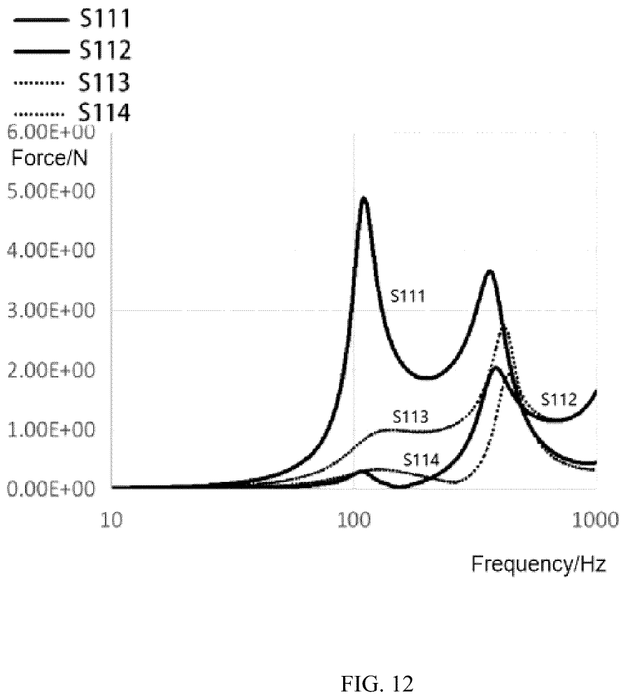

Referring to FIG. 12, FIG. 12 is a comparison diagram of the variation of the force on the diaphragm with frequency between the loudspeaker system provided in the conventional technology and the loudspeaker system shown in FIG. 3. In FIG. 12, the abscissa is the frequency in Hz, and the ordinate is the force on the diaphragm in N. In FIG. 12, the solid lines S111 and S112 are curves of the forces on the active diaphragm and the passive diaphragm varying with frequency in the conventional technology, and the dashed lines S113 and S114 in FIG. 12 are curves of the forces on the active diaphragm 50 and the passive diaphragm 20 in the loudspeaker system provided by the present disclosure varying with frequency. By comparison, it can be clearly seen that the displacements of the active diaphragm 50 and the passive diaphragm 20 in the loudspeaker system provided by the present disclosure are smaller at low frequency, so the overall size of the loudspeaker system is required to be smaller, which can effectively meet the design requirements of micro-loudspeakers.

Based on the above loudspeaker system, an electronic device is further provided according to the present disclosure, which can be arranged in electronic devices such as mobile phones, tablet computers, sound boxes, etc. When the above loudspeaker system is applied to an electronic device, a controller for driving the active diaphragm 50 to vibrate can be arranged in the electronic device to indirectly drive the passive diaphragm 20 to vibrate. For other details about the above electronic devices to realize the above technical solution, reference can be made to the description in the loudspeaker system provided in the above embodiments of the present disclosure, which will not be repeated herein.

The above-mentioned embodiments are only used to illustrate the technical solution of the present disclosure, but not to limit it. Although the present disclosure has been described in detail with reference to the foregoing embodiments, those skilled in the art should understand that it is still possible to modify the technical solution described in the foregoing embodiments, or to replace some technical features with equivalents. However, these modifications or substitutions do not make the essence of the corresponding technical solutions deviate from the spirit and scope of the technical solutions of various embodiments of the present disclosure, and should be included in the protection scope of the present disclosure.

What is claimed is:

1. A loudspeaker system, comprising:
a first housing, wherein a first accommodating cavity is defined in the first housing;
at least one passive diaphragm, arranged in the first accommodating cavity and dividing the first accommodating cavity into a first front cavity and a first rear cavity;
a second housing, wherein a second accommodating cavity is defined in the second housing, an active diaphragm is provided in the second accommodating cavity, the second accommodating cavity is divided into a second front cavity and a second rear cavity by the active diaphragm, and the second rear cavity is in communication with the first rear cavity to form a closed cavity;
a central magnetic block, fixed on a side of the at least one passive diaphragm away from the first front cavity, and moving along with the vibration of the at least one passive diaphragm in the first accommodating cavity in a first direction; and
a magnetic assembly, including a first magnetic member arranged on an inner side wall of the first front cavity and a second magnetic member arranged on an inner side wall of the first rear cavity, wherein a magnetizing direction of the first magnetic member and a magnetizing direction of the second magnetic member are the same as a magnetizing direction of the central magnetic block, and a cooperative force of the first magnetic member and the second magnetic member on the central magnetic block is zero under a non-vibrating state of the at least one passive diaphragm.

2. The loudspeaker system according to claim 1, wherein a projection of the first magnetic member and a projection of the second magnetic member respectively at least partially overlap with a projection of the central magnetic block in the first direction.

3. The loudspeaker system according to claim 1, wherein a first output port is defined on the first housing for communicating the first front cavity with an exterior, and the loudspeaker system radiates sound to the exterior of the first housing through the first output port.

4. The loudspeaker system according to claim 1, wherein a plurality of passive diaphragms are provided, a plurality of central magnetic blocks are provided and are arranged in one-to-one correspondence with the plurality of passive diaphragms, and the plurality of passive diaphragms are arranged in the first accommodating cavity in the first direction and spaced apart with each other.

5. The loudspeaker system according to claim 1, wherein the first rear cavity and the second rear cavity are communicated through at least one extension pipe to form the closed cavity.

6. The loudspeaker system according to claim 1, wherein the first rear cavity and the second rear cavity are directly communicated to form a third rear cavity, the at least one passive diaphragm is arranged between the first front cavity and the third rear cavity, and the active diaphragm is arranged between the second front cavity and the third rear cavity.

7. The loudspeaker system according to claim 1, wherein a second output port is defined on the second housing for communicating the second front cavity with an exterior, and the loudspeaker system radiates sound to the exterior of the second housing through the second output port.

8. The loudspeaker system according to claim 1, wherein the loudspeaker system further comprises at least one intermediate cavity in communication with the second front cavity, a third output port is defined on the at least one intermediate cavity for communicating the second front cavity with an exterior, and the loudspeaker system radiates sound to the exterior of the second housing through the third output port.

9. An electronic device, comprising a loudspeaker system, wherein the loudspeaker system includes:
a first housing, wherein a first accommodating cavity is defined in the first housing;
at least one passive diaphragm, arranged in the first accommodating cavity and dividing the first accommodating cavity into a first front cavity and a first rear cavity;
a second housing, wherein a second accommodating cavity is defined in the second housing, an active diaphragm is provided in the second accommodating cavity, the second accommodating cavity is divided into a second front cavity and a second rear cavity by the active diaphragm, and the second rear cavity is in communication with the first rear cavity to form a closed cavity;
a central magnetic block, fixed on a side of the at least one passive diaphragm away from the first front cavity, and moving along with the vibration of the at least one passive diaphragm in the first accommodating cavity in a first direction; and
a magnetic assembly, including a first magnetic member arranged on an inner side wall of the first front cavity and a second magnetic member arranged on an inner side wall of the first rear cavity, wherein a magnetizing direction of the first magnetic member and a magnetizing direction of the second magnetic member are the same as a magnetizing direction of the central magnetic block, and a cooperative force of the first magnetic member and the second magnetic member on the central magnetic block is zero under a non-vibrating state of the at least one passive diaphragm.
